(19) United States
(12) Patent Application Publication
(10) Pub. No.: US 2019/0024446 A1
(43) Pub. Date: Jan. 24, 2019

(54) SUPPORT ASSEMBLY FOR SUPPORTING A TILTABLE WINDOW

(71) Applicant: Harold Keith Braid, Braceborough/Stamford (GB)

(72) Inventor: Harold Keith BRAID, Stamford (GB)

(21) Appl. No.: 16/043,226

(22) Filed: Jul. 24, 2018

(30) Foreign Application Priority Data
Jul. 24, 2017 (GB) 1711859.7

(51) Int. Cl. E06B 7/28; E06B 3/50

(52) U.S. Cl. CPC E06B 7/28; E06B 3/5063

(57) ABSTRACT

A support assembly suitable for supporting a tiltable window in a tilted condition, said tiltable window including a window frame, a latch for releasably securing the tiltable window in a vertical orientation in a main frame, and an actuator arranged to actuate the latch in response to a user moving the actuator. The support assembly includes: a first support member arranged to be mounted on a surface, such as a floor, to support the tiltable window in the tilted condition; and a first connector attached to the first support member. The first connector includes a frame that is arranged to at least partly envelope a window frame member and is arranged to be releasably attached to the window frame member prior to the tiltable window being tilted out of the plane of the main frame. A window system including the support assembly, and a method for supporting a tiltable window using the support assembly are also disclosed.

### CROSS REFERENCE TO RELATED APPLICATIONS

This application claims priority to Foreign Patent Application GB 1711859.7 filed on Jul. 24, 2017, the entire disclosure of which is hereby incorporated by reference and relied upon.

### BACKGROUND OF THE INVENTION

### Field of the Invention

The present invention relates to a support assembly for supporting a tiltable window in a tilted condition, a window system including the support assembly, and a method for supporting a tiltable window. The invention is particularly applicable to sash windows.

### Description of Related Art

Sash windows typically comprise a pair of window sashes located and supported within vertical channels in side jambs of a window frame. The window sashes are arranged to vertically slide within the window frame to allow for opening and closing of the window. A counterbalance mechanism is provided to counterbalance the weight of the window sashes and allow easier vertical sliding of the window sashes. Modern sash windows are also arranged such that the window sashes can be tilted out of the window frame about a horizontal axis, which is typically located along or towards the bottom edge of the window sashes. Such tilting of the window sashes is provided to allow maintenance access, and in particular allow for easier cleaning of the windows with the window sashes generally being arranged to tilt inwards.

In such arrangements tilt restrictor arms (sometimes referred to as tilt stays or tilt restrictors) are typically provided in order to support the weight of the window sashes when tilted from the window frame. One end of the tilt restrictor is located and engaged in the window jamb channel and the other end of the tilt restrictor is attached to the sash part way along the side of the sash and at a position spaced from the pivot bar and axis about which the window tilts. In order to allow for tilting of the window at least one of the ends of the tilt restrictor is slidably engaged with the respective window jamb and/or window sash such that whilst it is retained it can slide along the length of the window sash/jamb. Whilst conventional tilt restrictor arrangements function adequately and prevent excessive tilting of the window sashes, such arrangements can be improved in particular in terms of ease of assembly and attachment to the window and restrictor, as well as in terms of providing improved operation of the window sashes. Specifically conventional tilt restrictors can be fiddley and difficult to attach to the window sashes and/or window jamb and such arrangements can be relatively difficult to install and/or cause difficulties when installing the window sashes in particular during replacement of the window sashes within the window frame. Furthermore whilst it is generally desirable to restrict the titling of the window sashes, in certain circumstances, for example during replacement or in an emergency, it can be desirable to allow for further tilting and/or removal of the sashes.

Furthermore, tilt restrictors restrict the extent to which the window sashes can pivot inwardly. This can make it difficult to clean the entire external surface of the window sash. Also, tilt restrictors are relatively expensive, and each window typically requires at least two tilt restrictors, and typically a pair of tilt restrictors for each sash, which can add significantly to the cost of the window.

It is therefore desirable to provide an improved means for supporting windows in a tilted condition. In particular, it is an object of the invention to provide a means of supporting window sashes in a tilted out of frame orientation that improves the ease with which the windows can be cleaned.

### BRIEF SUMMARY OF THE INVENTION

According to one aspect of the invention there is provided a support assembly for supporting a tiltable window in a tilted condition, said tiltable window including a window frame, and a latch for releasably securing the tiltable window in a vertical orientation in a main frame. The support assembly includes: a first support member arranged to be mounted on a surface, such as a floor, to support the tiltable window in the tilted condition; and a first connector attached to the first support member.

The support member supports at least part of the weight of the window in the tilted condition. Thus the invention obviates the need for window tilt restrictors. Instead at least one support member is provided which can support the window in the tilted condition. This enables the window to tilt through a larger angle, which helps a user to clean the entire window surface. It is also easier for a person to escape during an emergency situation since the aperture presented is larger. Furthermore, at its most efficient, only one support assembly is required for all of the windows in a building since the first support member is releasably attachable to the window, and can be moved from window to window. The cost of providing one support assembly per dwelling is typically much lower than providing pairs of tilt restrictors for each sash. The invention is particularly applicable to sash windows. Of course, the support assembly can include any number of support members. In practice, a suitable number of support members will be provided according to the number of windows in the building. Typically one to three support members would adequate for most domestic dwellings.

The first connector can be arranged to be releasably attached to the window frame prior to the tiltable window being tilted out of the plane of the main frame. Attaching the support assembly to the window frame prior to tilting the window out of the main frame provides a highly convenient method of supporting the window, and is advantageous from a safety perspective.

The first connector can include a frame that is arranged to at least partly envelope a window frame member.

The tiltable window can include a securing member for securing the first connector to the window frame. The securing member provides a very secure connection with the window frame member. The securing member prevents the first connector from disengaging the window frame in use. The securing member can comprise an actuator arranged to actuate the latch in response to a user moving the actuator. The securing member can comprise a window frame screw element. The securing member can be arranged to clamp the first connector to the first window frame.

The first connector can include a formation adapted to interact with the securing member. The formation can include an aperture or recess. At least part of the securing member can be received in the formation.

The position of the securing member can be adjusted with respect to at least one of the latch and window frame. The securing member can include a finger-grip part that is arranged to be gripped by the user, for example when adjusting the position of the securing member with respect to the window frame. The finger-grip part can be used to clamp the first connector to the window frame member.

The securing member can be releasably attachable to one of the latch and the window frame.

One of the actuator and the latch can include a threaded member and the other of the actuator and the latch can include a threaded hole. This enables the position of the actuator with respect to the latch to be adjusted. The actuator can be removed from the latch by rotating the actuator with respect to the latch.

One of the window frame screw element and the window frame can include a threaded member and the other of the window frame screw element and the latch can include a threaded hole. This enables the position of the window frame screw element with respect to the window frame to be adjusted. The window frame screw element can be removed from the window frame by rotating the window frame screw element with respect to the window frame.

The tiltable window can include a second latch for releasably fixing the vertical orientation of the tiltable window with respect to a main frame. The tiltable window can include a second securing member. The second securing member can comprise a second actuator arranged to actuate the second latch in response to a user moving the actuator. The second securing member can comprise a second window frame screw element. In some embodiments, at least part of the second securing member can be received in the formation. Thus, with a single formation, the user is able to secure the first connector to the window frame with either the securing member or the second securing member.

The first connector can include a second formation adapted to interact with the second securing member. The second formation can include an aperture or recess. At least part of the second securing member can be received in the second formation.

The second securing member can be arranged to secure the first connector to the window frame, for example via the second formation. Thus the first connector can be secured to the window frame be either the securing member or second securing member according to a user selection. This enables the support to be used on either the left or right sides of the window. Typically the first and second securing members are spaced apart on a window frame towards the left and right sides thereof, and therefore the first connector interacts with only one of the securing members at a time, according to user selection.

The position of the second securing member can be adjusted with respect to at least one of the second latch and the window frame. The second securing member can be arranged to clamp the first connector to the window frame. The second securing member can include a second finger-grip part that is arranged to be gripped by the user when adjusting the position of the second securing member. The second finger-grip part can be used to clamp the first connector to the window frame member. That is, the use has the option of attaching the first connector to the window frame member adjacent the securing member or adjacent the second securing member.

The second securing member can be releasably attachable to one of the second latch and the window frame.

One of the second actuator and the second latch can include a second threaded member and the other of the second actuator and the second latch can include a second threaded hole. This enables the position of the second actuator with respect to the second latch to be adjusted. The second actuator can be removed from the second latch by rotating the second actuator with respect to the latch.

One of the second window frame screw element and the window frame can include a threaded member and the other of the second window frame screw element and the latch can include a threaded hole. This enables the position of the second window frame screw element with respect to the window frame to be adjusted. The second window frame screw element can be removed from the window frame by rotating the second window frame screw element with respect to the window frame.

The window frame member is typically an upper frame member when the window is in its normal vertical orientation within the main frame.

The window frame member can have upper, lower, inner and outer sides when the window can be in its normal vertical orientation. For example, window frame member can be substantially cuboid, and typically has an elongate cuboid structure.

The first connector frame can be adapted to engage a plurality of the upper, lower, inner and outer sides, and preferably at least three of the upper, lower, inner and outer sides. In some embodiments, the first connector is adapted to engage each of the upper, lower, inner and outer window frame member sides.

The first connector can include an upper wall arranged to engage an upper side of the window frame member (herein after “upper wall”).

The first connector can include a wall arranged to engage an outer side of the window frame member (herein after “outer wall”).

The first connector can include a wall arranged to engage an inner side of the window frame member (herein after “inner wall”).

The first connector can include a wall arranged to engage a lower side of the window frame member (herein after “lower wall”).

In preferred embodiments the frame includes upper, lower, inner, and outer walls and the frame is arranged to partly envelope the window frame member. The frame can be hook-shaped. The hook-shaped frame is adapted to hook on to the window frame member.

The first connector can include an opening located between the lower and outer walls. The opening can be sized and shaped to receive part of the window frame member. The first connector can be arranged to fit snuggly onto window frame member in a releasable manner, via the opening.

The upper wall is typically arranged to extend transversely across the full width of the upper side of the window frame member. The upper wall can include a stepped portion located towards one end thereof, and preferably the end closest to the outer side of the frame member. The stepped portion enables the wall to flex when attached and removed from the window frame member. The first and second formations for receiving the actuators are preferably formed in the upper wall. At least one of the first and second formations can be formed in the upper wall.

The outer wall typically extends transversely across a portion of the outer side of the window frame member, for example less than or equal to 50% of the width. This helps the first connector to be releasably attached to the window frame member. The outer wall can include a rib that can be arranged to engage a groove formed in the outer side of the window frame member.

The lower wall typically extends transversely across a portion of the width of the lower side of the window frame member, for example less than or equal to 20% of the width of the lower side, preferably less than or equal to 15% of the width of the lower side. This helps the first connector to be releasably attached to the window frame member.

The inner wall is typically arranged to extend transversely across the full width of the inner side of the window frame member.

The upper wall can protrude perpendicularly from the inner wall, in the general direction of the outer wall. The lower wall can protrude perpendicularly from the inner wall, in the general direction of the outer wall. The upper wall can be arranged parallel to the lower wall. The outer wall can extend perpendicularly from the upper wall, generally in the direction of the lower wall. The outer wall can be arranged parallel to the inner wall.

At least part of the first connector can be flexible. This enables the outer wall to adjust its orientation with respect to the upper wall. For example, at least one of the upper, inner, lower and outer walls can be flexible. Preferably at least one of the upper and outer walls is flexible. This helps the first connector to be attached to and removed from the window frame member. In preferred embodiments the first connector is arranged to flex resiliently.

The first connector can be adapted to clip on to the window frame member in a releasable manner.

The first connector can comprise a moulded plastics component. For example, the first connector can be moulded from a thermoplastic. The material can be selected to enable the first connector to flex. Alternatively, the first connector can be made from a metal such as aluminium.

The first connector can be pivotally attached at one end of the first support member. This enables the first support member to change its orientation with respect to the first window, for example when hanging from the first window.

Each of the first connector and the first support member can include a plurality of mounting members. The mounting members of the first connector can be interleaved with the mounting members of the first support. A pivot pin can pivotally connect the first connector mounting members to the support member mounting members. This arrangement provides a robust connection. The mounting members can provide bearing surfaces that guide relative movement of the support member with respect to the first connector. The mounting members permit relative pivoting movement, but substantially prevent other relative movement. Preferably the first connector mounting members protrude from the inner wall, generally in a direction that is opposite to at least one of the upper and lower walls.

At least one of the mounting members can include a profiled surface in order to limit relative pivoting movement of first connector with respect to the first support member. For example, the profiled surface can be arranged to engage with one of the first connector and the first support member. In some embodiments, the profiled surface is arranged to engage the inner wall.

The length of the first support member can be adjustable, and is preferably telescopically adjustable.

The first support member can include first and second parts that are moveable with respect to one another. At least one of the first and second parts can be tubular, and one of the first and second parts is mounted within the other of the first and second parts. The first support member can include locking means for fixing the position of the first part with respect to the second part.

The locking mechanism can comprise a twist-lock locking mechanism. In some embodiments twisting the first part with respect to the second part in a first rotational direction locks the longitudinal translational position of the first part with respect to the second part. Twisting the first part with respect to the second part in a second rotational direction unlocks the longitudinal translational position of the first part with respect to the second part. This enables the first part to move translationally with respect to the second part. The locking mechanism can include a formation that changes its shape and or position in response to relative rotational movement of the first part with respect to the second part, thereby locking and/or unlocking the longitudinal translation position of the first part with respect to the second part.

The support assembly can include a second support member having a second connector attached thereto. The second support member can be similar to any configuration of the first support member described herein. The second connector can be similar to any configuration of the second connector described herein. The second connector can be releasably secured to the window frame by way of the securing member or second securing member.

At least one of the first and second support members can comprise a support post. The support post provides a simple and effective window support.

According to another aspect of the invention there is provided window system, comprising: a support assembly including a first support member arranged to engage a surface, such as a floor, to support the first window in the tilted condition and a first connector attached to the first support member; and a window assembly having a main frame, a first window having a first window frame, and a latch arranged to releasably secure the first window in a vertical orientation in the main frame. The first window is pivotally mounted in the main frame such that the first window is tiltable out of the plane of the main frame by pivoting the first window about a first pivot axis.

The system enables the window to be cleaned more easily since there are no tilt restrictors to restrict the extent to which the windows are tiltable. Thus substantially the whole surface of the window is accessible to the user. The or each window is arranged to freely pivot. In practicable embodiments the or each window is arranged to pivot through an angle of approximately 80 to 85 degrees.

The support assembly can be arranged according to any configuration described herein.

The first connector can be releasably attached to a window frame member while the first window is in a substantially vertical orientation within the main frame.

The first connector includes a frame that is arranged to at least partly envelope the window frame member.

The window can include a securing member, which is arranged to releasably secure the first connector to the first window frame. The securing member can be an actuator arranged to actuate the latch in response to a user moving the actuator. The securing member can be a window frame screw element. The support assembly is arranged to support the first window in the tilted condition.

The position of the securing member can be adjustable with respect to at least one of the latch and the window frame.

The securing member can be releasably attachable to one of the latch and the window frame.

The securing member can be arranged to clamp the first connector to the window frame member. The securing member can include a finger-grip part that can be arranged to be gripped by the user. The finger-grip part can be used to clamp the first connector to the window frame member.

The first connector can include a formation, such as a hole or recess, and at least part of the securing member can be arranged to engage the formation to secure the first connector to the window frame member.

One of the actuator and the latch can include a threaded member and the other of the actuator and the latch can include a threaded hole, wherein the position of the actuator with respect to the latch can be adjustable by rotating the threaded member within the threaded hole. The threaded member is typically connected to the finger-grip part.

One of the window frame screw element and the window frame includes a threaded member and the other of the window frame screw element and the window frame includes a threaded hole, wherein the position of the window frame screw element with respect to the window frame is adjustable by rotating the threaded member within the threaded hole. The position of the window frame screw element can be adjustable with respect to the window frame. The window frame screw element can be releasably attachable to the window frame.

The first window can include a second latch arranged to releasably secure the first window in the vertical orientation in the main frame. The first window can include a second securing member. The second securing member can comprise a second actuator arranged to actuate the second latch in response to a user moving the second actuator. The second securing member can comprise a second window frame screw element.

The support assembly can include a second support member and a second connector attached to the second support member. The second connector can include a second frame that is arranged to at least partly envelope the window frame member. The second frame can be arranged to be releasably attached to the window frame member prior to the first window being tilted out of the plane of the main frame. The second securing member can be arranged to releasably secure the second connector to the first window frame. The second securing member can be arranged to clamp the second connector member to the first frame member.

The second securing member can include a second finger-grip part that can be arranged to be gripped by the user. The second finger-grip part can be used to clamp the second connector to the window frame member.

The position of the second securing member can be adjustable with respect to at least one of the second latch and the first window frame. In some embodiments at least, the positions of the first and second connectors on window frame can be interchangeable. For example, the first connector can be clamped to the first window frame by the second securing member and the second connector can be clamped to the first window frame by the securing member.

The second securing member can be releasably attachable to one of the second latch and the first window frame.

One of the second actuator and the second latch can include a second threaded member and the other of the second actuator and the second latch can include a second threaded hole, wherein the position of the second actuator with respect to the second latch can be adjustable by rotating the second threaded member within the second threaded hole. The second threaded member can be connected to the second finger-grip part.

One of the second window frame screw element and the window frame can include a threaded member and the other of the second window frame screw element and the latch can include a threaded hole. This enables the position of the second window frame screw element with respect to the window frame to be adjusted. The second window frame screw element can be removed from the window frame by rotating the second window frame screw element with respect to the window frame.

The window assembly comprise a sash window assembly, at least one of the first and second windows can be arranged to slide vertically within the main frame and at least one of the first and second pivot axes can be arranged horizontally.

In some embodiments the positions of the first and second connectors on window frame member can be interchangeable. For example, the first connector can be clamped to the first window frame by the second securing member. The second connector can be clamped to the first window frame by the securing member.

The window assembly can include a second window. The second window can be pivotally mounted in the main frame such that the second window can be tiltable out of the plane of the main frame by pivoting the second window about a second pivot axis. The first window is arranged to support the second window when the second window is in the titled condition. The second window can include a second glazing unit and a second frame.

At least one of the first and second windows can be arranged to slide vertically within the main frame, and preferably each window is arranged to slide vertically within the main frame. The first window is offset from the second window within the main frame, thereby allowing the first and second windows to overlap one another. Thus the first window moves in a different vertical plane from the second window. In preferred embodiments the first window is a lower window. In preferred embodiments the first window is an inner window. In preferred embodiments the second window is an upper window. In preferred embodiments the second window is an outer window.

At least one of the first and second pivot axes can be arranged horizontally. Thus the windows pivot in a vertical plane. In preferred embodiments the first pivot axis is arranged towards a lower part of the first window. Pivot pins extend out of the first window frame into a first set of vertical channels located in the main frame. The pivot pins are slidable within their respective channels. In preferred embodiments the second pivot axis is arranged towards a lower part of the second window. Pivot pins extend out of the second window frame into a second set of vertical channels located in the main frame. The pivot pins are slidable within their respective channels. The main frame is oriented substantially vertically. Typically at least one of the first and second windows is arranged to tilt into a room.

The latches are arranged to maintain the window in the plane of the main frame. The actuators are arranged to operate the latches. When the latches are released, the window can be tilted out of the plane of the main frame. The actuators are manually operable. Each latch actuator can be arranged for sliding movement. Each latch actuator can be arranged for lateral movement.

The window assembly comprise a sash window assembly. The first window comprises a first sash window. Preferably the first sash window is a lower sash window. That is, in its normal closed condition. The second window comprises a second sash window. Preferably the second sash window is an upper sash window. That is, in its normal closed condition.

According to another aspect of the invention there is provided method for supporting a tiltable window, including: providing a window assembly including a main frame and a first window, the first window having a first window frame, and a latch for releasably securing the first window in a vertical orientation in the main frame, wherein the first window is pivotally mounted in the main frame; providing a support assembly including a first support member and a first connector attached to the first support member; releasably attaching the first connector to the first window frame, the first connector including a frame that is arranged to at least partly envelope a window frame member; tilting the first window out of the plane of the main frame by pivoting the first window about a first pivot axis; mounting the first support member on a surface, such as the floor, such that the first support member supports the first window in the tilted condition.

The method enables the window to be cleaned more easily since there are no tilt restrictors to restrict the extent to which the windows are tiltable. Thus substantially the whole surface of the window is accessible to the user. The first connector is attached to a first end of the first support member. A second end of the first support member is mounted on the surface.

The method can include releasably securing the first connector to the first window frame with the actuator while the first window is in a substantially vertical orientation within the main frame.

The support assembly can be arranged according to any configuration described herein.

The window assembly can comprise any configuration described herein.

The method can include the first support member hanging downwards from the first window frame. The method can include adjusting the orientation of the first support member with respect to the first window as the window is tilted out of the main frame.

The method can include the first window having a securing member, such as an actuator arranged to actuate the latch in response to a user moving the actuator or a window frame screw element, and securing the first connector to the first window frame using the securing member.

The method can include adjusting the position of the securing member with respect to at least one of the latch and the first window frame.

The method can include clamping the first connector to the first window frame with the securing member.

The method can include the first window having a second latch arranged to releasably secure the first window in the vertical orientation in the main frame, and a second securing member. The second securing member can comprise a second actuator arranged to actuate the second latch in response to a user moving the second actuator or a second window frame screw element.

The method can include the support assembly having a second support member and a second connector attached to the second support member.

The method can include releasably attaching the second connector to the first window frame. The second connector can include a second frame that is arranged to at least partly envelope the window frame member. The method can include releasably attaching the second frame to the window frame member prior to the first window being tilted out of the plane of the main frame. The method can include releasably securing the second connector to the first window frame with the second securing member. The method can include mounting the second support member on a surface, such as the floor, such that the second support member supports the first window in the tilted condition.

The method can include adjusting the position of the second securing member with respect to at least one of the second latch and the first window frame.

The method can include clamping the second connector to the first window frame with the second securing member.

The method can include the window assembly having a second window, wherein the second window is pivotally mounted in the main frame. The method can include tilting the second window out of the plane of the main frame, and supporting the second window in the tilted condition. The second window is preferably supported by the first window. In preferred embodiments, at least one separating member, such as a cloth, sponge of block of foam, is located between the first and second windows. This prevents the windows from marking one another.

The method can include adjusting the length of at least one of the first and second support members.

The method can include sliding at least one of the first and second windows within the main frame. The first and second windows are arranged to slide vertically in the main frame.

The method can including attaching a brace to the first and second support members.

The method can include removing the first connector from the first window frame. The method can include adjusting the position of the securing member to remove the first connector. The first securing member can be separated from one of the first latch and first window frame to remove the first connector.

The method can include removing the second connector from the second window frame. The method can include adjusting the position of the second securing member to remove the second connector. The second securing member can be separated from one of the second latch and first window frame to remove the second connector.

According to another aspect of the invention there is provided a support assembly for supporting a tiltable window in a tilted condition. The support assembly can include a first support member and a first connector attached to the first support member. The first connector is adapted to releasably attach the first support member to a window frame. The first support member is mountable on a surface to support the window in the tilted condition. The surface is preferably located below the window, for example the surface can comprise a floor. The first connector can include at least one of an upper wall, outer wall, inner wall and lower wall. Preferably the first connector includes the upper wall and at least one of the outer wall, inner wall and lower walls. Preferably the first connector includes the upper wall and at least two of the outer wall, inner wall and lower walls. Preferably the first connector includes the upper wall, outer wall, inner wall and lower wall. The at least one wall provides a frame that is arranged to at least partly envelope a window frame member having upper, outer, inner and lower sides. The first connector can include an opening arranged to receive the window frame member. The opening can be located between the lower and outer walls.

According to another aspect of the invention there is provided a support assembly for supporting a tiltable window in a tilted condition, the support assembly, including: a first support member mountable on a floor to support the window in the tilted condition; and a first connector attached to the first support member; wherein at least part of the first connector is arranged to flex resiliently and said first connector is adapted to clip on to a window frame member in a releasable manner thereby releasably attaching the first support member to the window, the first connector is pivotally attached to the first support member thereby enabling the first support member to change its orientation with respect to the window as the window is moved to the tilted condition.

According to another aspect of the invention there is provided a method for supporting a tiltable window, including providing a window assembly including a main frame and a first window having a first window frame, wherein the first window is pivotally mounted in the main frame; providing a support assembly including a first support member and a first connector attached to the first support member, wherein at least part of the first connector is arranged to flex resiliently, and the first connector is pivotally attached to the first support member; releasably attaching the first support member to the first window by clipping the first connector to the first window frame, the arrangement being such that the first support member hangs downwards from the first frame; tilting the first window out of the plane of the main frame by pivoting the first window about a first pivot axis, thereby adjusting the orientation of the first support member with respect to the first window; and mounting the first support member on a floor such that the first support member supports the first window in the tilted condition.

According to another aspect of the invention there is provided a window system, comprising: a support assembly including a first support member and a first connector attached to the first support member; and a window assembly having a main frame, a first window having a first window frame, a latch arranged to releasably secure the first window in a vertical orientation in the main frame, and a securing member; wherein the first window is pivotally mounted in the main frame such that the first window is tiltable out of the plane of the main frame by pivoting the first window about a first pivot axis; wherein the securing member is arranged to secure the first connector to the window frame member and the support assembly is arranged to engage a surface, such as a floor, to support the first window in the tilted condition.

### BRIEF DESCRIPTION OF THE SEVERAL VIEWS OF THE DRAWINGS

Embodiments of the present invention will now be described by way of example only with reference to the following figures in which:

FIG. 1a is a side view of a window support member in accordance with an embodiment of the invention;

FIG. 1b is a front view of the window support member of FIG. 1a;

FIG. 2 is an enlarged isometric view from the front and side of a connector portion of the window support member of FIG. 1a;

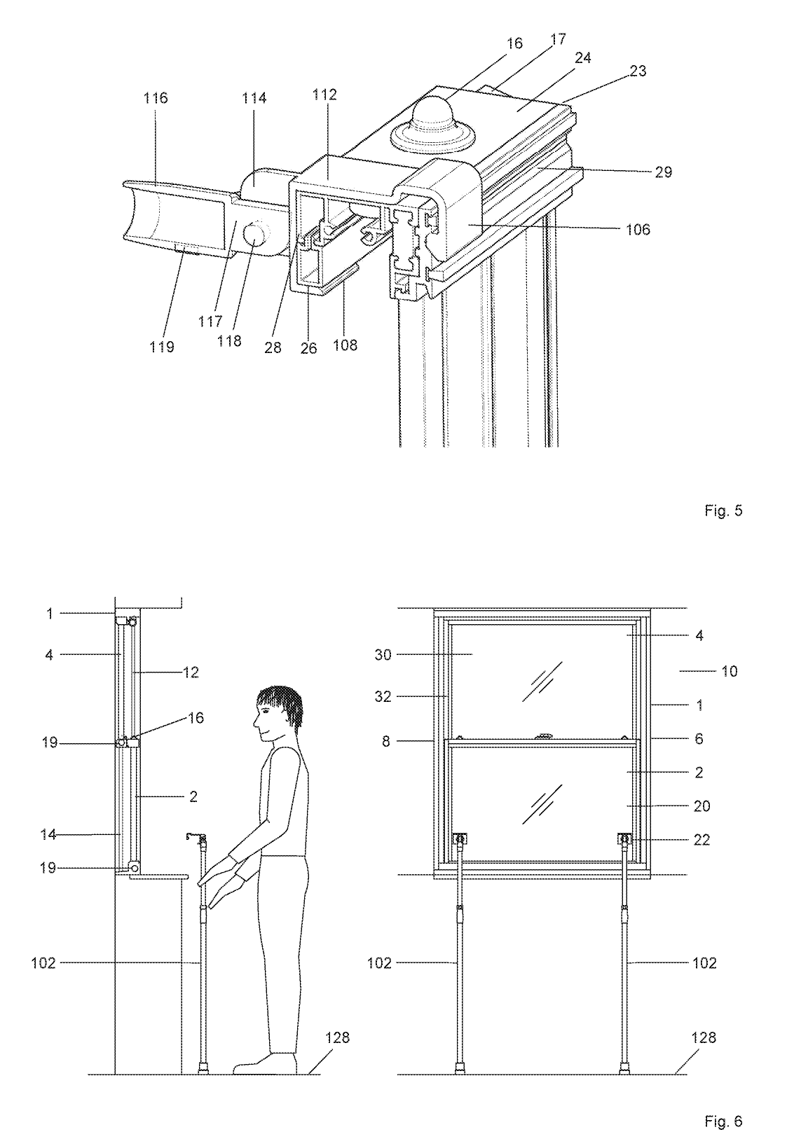

FIG. 3 is an enlarged isometric view from the rear and side of a connector portion of the window support member of FIG. 1a;

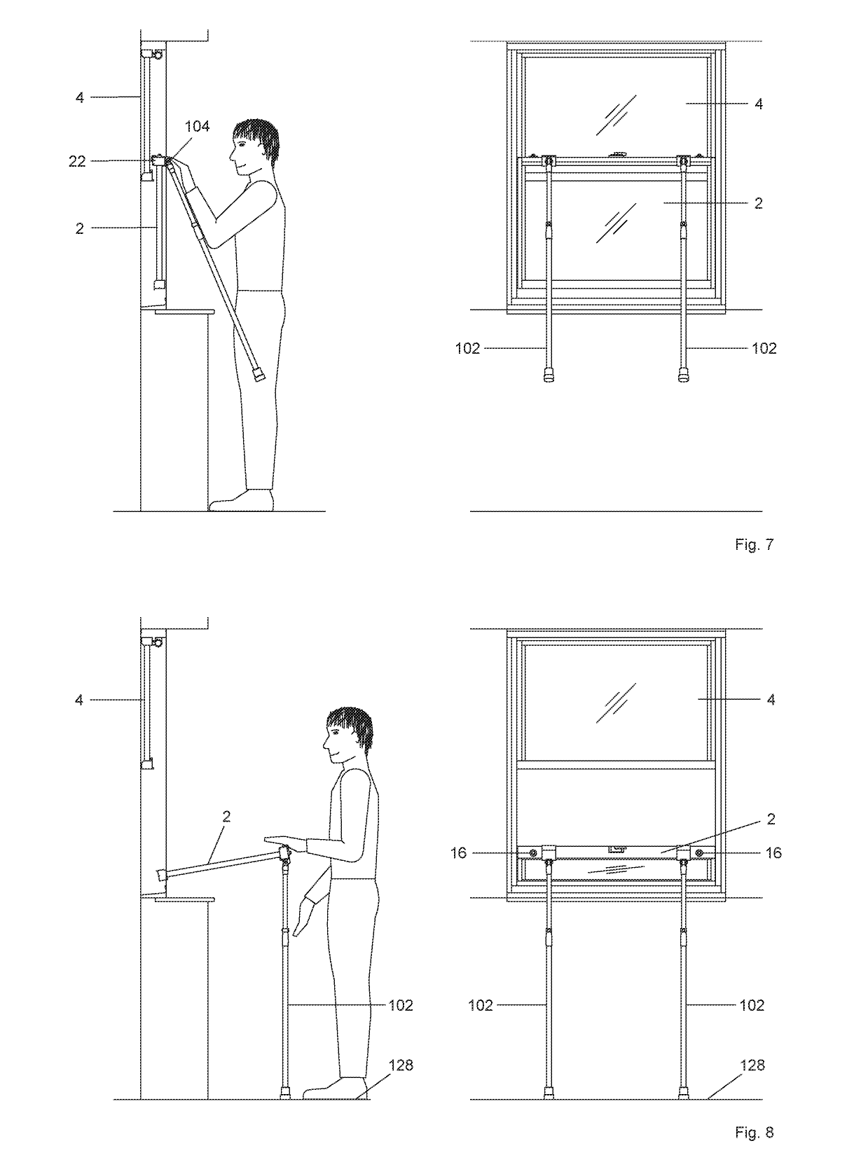

FIG. 4 is an isometric view of two connector portions according to the arrangements of FIGS. 2 and 3 attached to a window frame;

FIG. 5 is a cross-sectional view of the arrangement shown in FIG. 4;

FIGS. 6 to 15 show steps in a method for supporting a tiltable window in an out of frame orientation;

FIG. 16 is a sectional view of part of the window, with support attached thereto, the window being in a substantially vertical orientation;

FIG. 17a is a sectional view of part of the window, with support attached thereto, the window being in a tilted condition;

FIG. 17b is a front view of the arrangement shown in FIG. 17a;

FIGS. 18-21 show detailed views of the connector portion being attached to the window, in particular how the connector portion resiliently deforms when attached to the window; and

FIGS. 22a and 22b, show a locking mechanism for fixing the length of the support member.

### DETAILED DESCRIPTION OF THE INVENTION

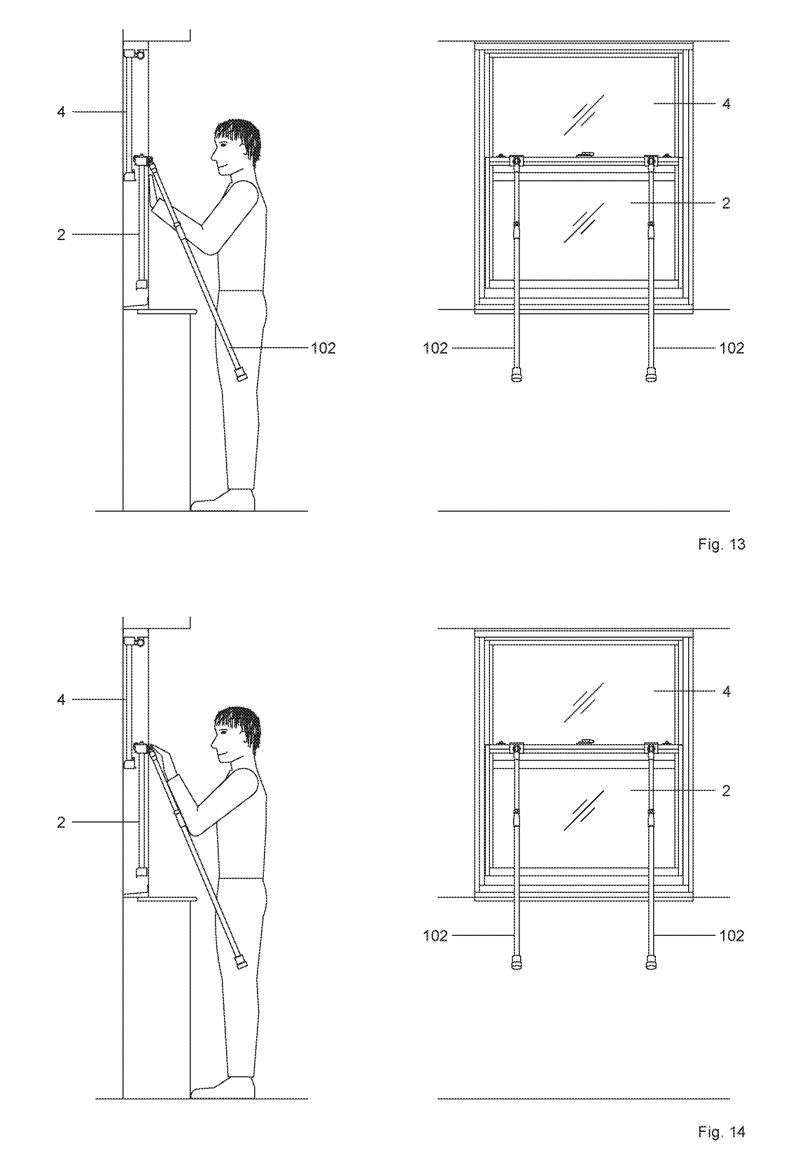

Referring to FIG. 6, a sash window assembly 10 comprises a main frame 1 including vertical side frame jamb members 6,8, a first (lower) sash 2 and a second (upper) sash 4 both of which are vertically slidably located within the main frame 1. The first sash 2 includes a first glazing unit 20 and a first window frame 22. The second sash includes a second glazing unit 30 and a second window frame 32.

The first and second sashes 2,4 are disposed generally vertically in an offset overlapping arrangement with the first and second sashes 2,4 disposed closely adjacent to each other and in operation sliding one behind the other. The vertical window jamb members 6,8 each define double vertically extending window jamb channels 12,14 for the respective sashes 2,4. The window jamb channels 12,14 of the double channel section in each window jamb 6,8 are disposed side by side adjacent to and along the length of the window side jambs 6,8 adjacent to the lateral side of the respective sashes 2,4. These window jamb channels 12,14 have an open part which faces the respective lateral sides of the sashes 2,4. The main frame 1, and window side jambs 6,8 are typically fabricated from extruded UPVC sections which are joined together, although other materials for example metal, Aluminium or wood may be used.

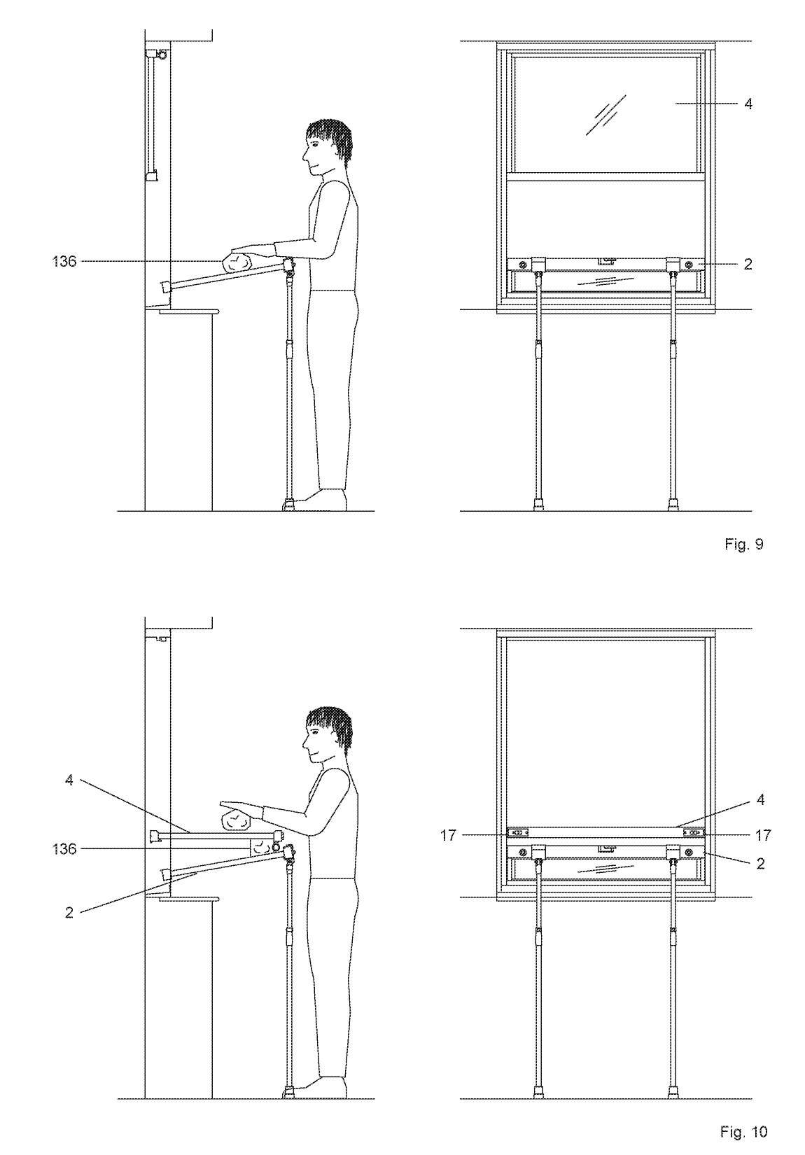

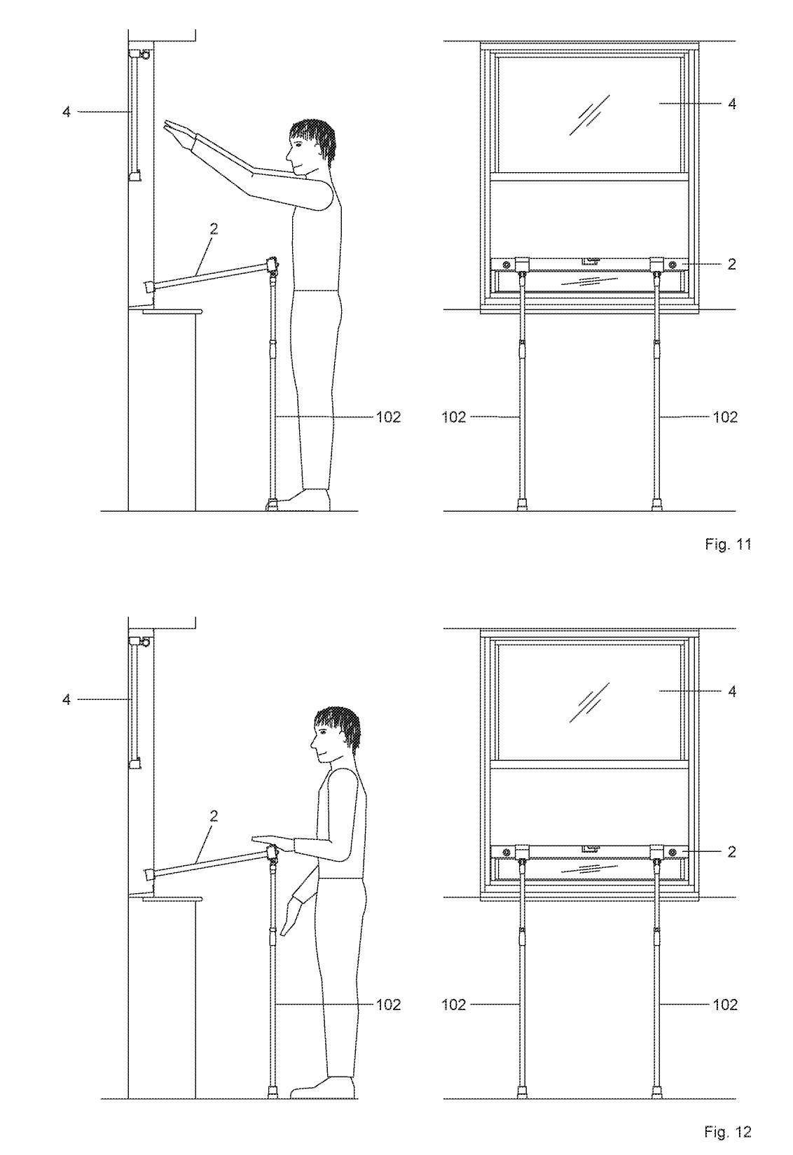

Each sash 2,4 is engaged and supported in the main frame 1 by a pair of pivot bars 19 located towards the lower part of the sashes 2,4. The pivot bars 19 extend and project laterally from the sides of the sashes 2,4. Pairs of tilt latches 17 (see FIGS. 4 and 5) for each sash 2,4 are located towards the upper part of the first and second sashes 2,4 and similarly project laterally from the sides of the sashes 2,4. The tilt latches 17 are actuated by actuators 16. The distal ends of the tilt latches 17 and pivot bars are engaged within the respective window jamb channels 12,14 thereby slidably locating the first and second sashes 2,4 within the main frame 1.

Each actuator 16 is releasably attached to its respective latch 17. Each latch 17 includes a threaded hole 182. Each actuator 16 comprises a finger-grip part 184 and a threaded member 186. The threaded member 186 protrudes from the finger-grip part 184. The actuator 16 is attached to its respective latch 17 by screwing the threaded member 186 into the respective threaded hole 182, by a user turning the finger-grip part 184.

Counterbalance arrangements (not shown) to counterbalance the weight of the first and second sashes 2,4 and make vertical sliding of the first and second sashes 2,4 easier are mounted and located within the jamb channels 12,14 and attach to the sashes 2,4, and typically to the pivot bars 19. Specifically the pivot bars 19 may be engaged in sash shoes slidably mounted in the window jamb channels 12,14 and connected to the counterbalance arrangements, for example one end of a constant force balance or spiral balance. Such counterbalance arrangements typically comprise one or more constant force balances, or one or more spiral balances, and are well known in the art for example being described in UK published patent applications GB2369644, and GB2380758, or U.S. Pat. No. 6,412,144 and U.S. Pat. No. 6,393,661, which also generally describe such sash windows.

The tilt latches 17 are laterally retractable with respect to the first and second sashes 2,4 such that the distal ends of the tilt latches 17 can be withdrawn from the window frame jamb channels 12,14. Such withdrawal, in use, allows the upper part of the first and second sashes 2,4 to be disengaged from the main frame 1 allowing the first and second sashes 2,4 to be tilted and pivoted about the pivot bars 19 and a horizontal axis through the lower edge of the first and second sashes 2,4 as illustrated in FIGS. 6 to 8.

It can be seen from FIG. 8 that, for a window assembly 10 without tilt restrictors, the tilted first and second sashes 2,4 provide an increased opening for example to provide easier emergency escape through the window, and also provide increased and better maintenance access, as well as allowing for easier removal and/or installation of the sashes 2,4. Specifically when the tilt restrictors are not included in the window assembly 10, the first and second sashes 2,4 can be fully tilted (typically approximately horizontally, by around 80 to 90 degrees)).

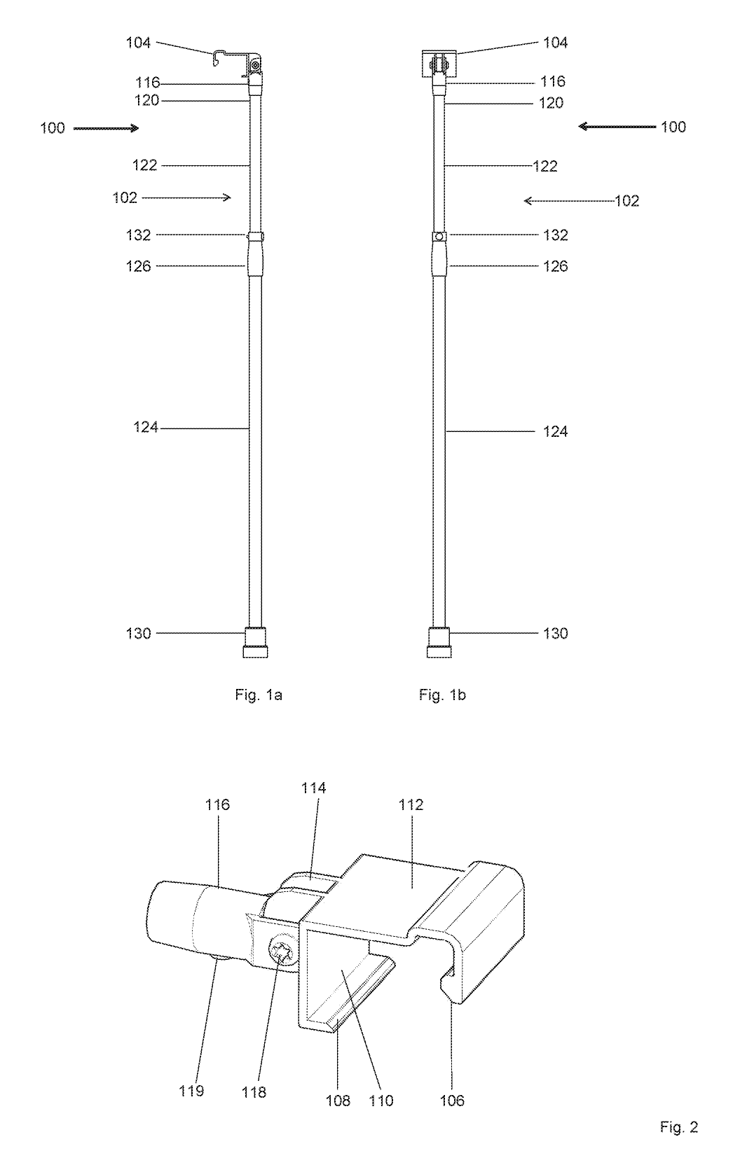

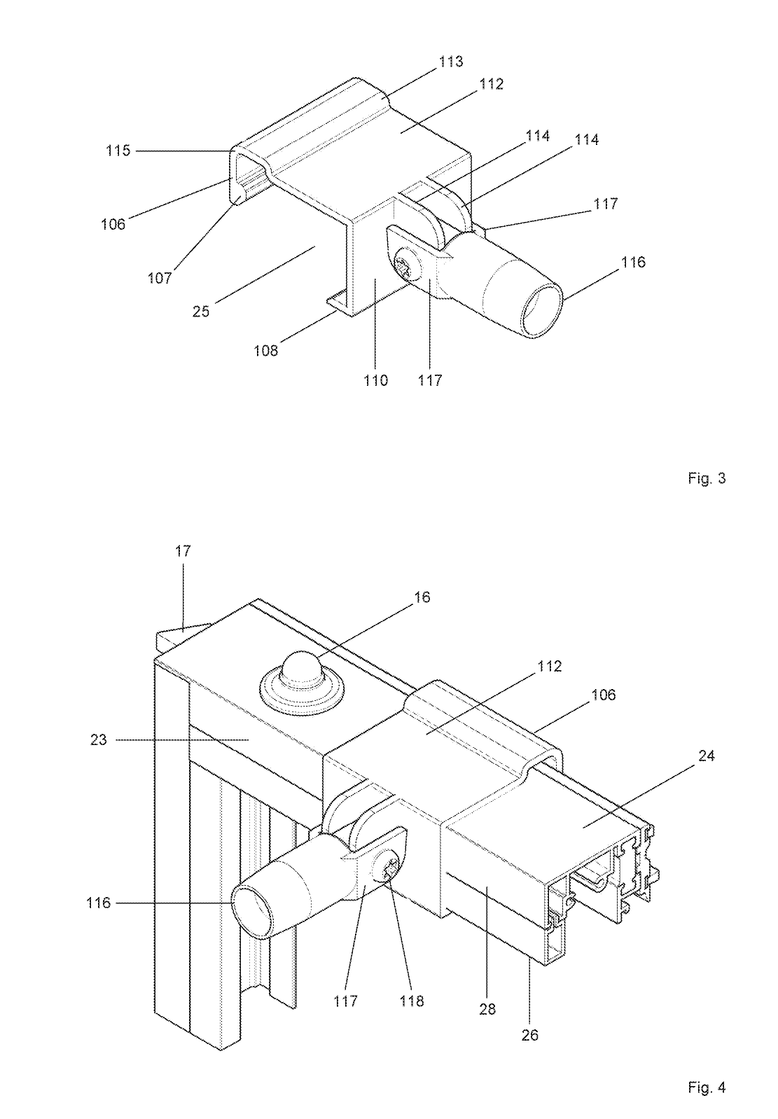

FIGS. 1a and 1b each show a support assembly 100 for supporting the sashes 2,4 in the tilted condition. The support assembly 100 includes at least one window support comprising a support member 102, which is typically a support post, and a connector 104. Preferably the support assembly 100 includes a plurality of support members 102, typically two.

The connector 104 is arranged to releasably attach the member 102 to the first sash 2. In particular, the connector 104 is arranged to releasably attach the support member 102 to the first window frame 22. The connector 104 includes a hook-like formation that is sized and shaped to hook on to a horizontal frame member 23 of the first window frame 22. The frame member 23 is an upper frame member, when the first sash 2 is in its vertical orientation.

The hook formation is able to flex a little. For example, the connector 104 can be made from a plastics material, which enables the connector 104 to flex resiliently. Thus the hook formation is resiliently deformable to a limited extent. The hook formation has an opening 25 that is sized and shaped to receive the frame member 23. The hook formation has sufficient flexibility to enable it to clip on to the frame member 23 and to be removed from the frame member 23.

The hook formation comprises a frame-like structure having first (upper) and second (lower) walls 112,108 that protrude outwardly from a connecting side wall 110. The upper part includes a wall 106 at a distal end of the upper wall 112, which curves downwards from the upper wall. The wall 106 defines a second side wall, which is substantially parallel to the connecting side wall 110. The wall 106 is shorter in height than the connecting side wall 110. The wall 106 is somewhat stubby. The opening 25 is located between the wall 106 and the lower wall 108.

The upper and lower walls 112,108 protrude substantially perpendicularly from the side wall 110, when in a non-deformed state. The upper and lower walls 112,108 are substantially parallel with one another. The upper wall 112 is arranged to engage a first (upper) side 24 of the frame member 23. The first side 24 faces generally upwards when the first sash 24 is in its vertical orientation in the main frame 1. The upper wall 112 is arranged to extend transversely across the full width of the upper side 24 of the frame member. The lower wall 108 is arranged to engage a second (lower) side 26 of the frame member 23. The second side 26 is arranged substantially opposite to the first side 24. The second side 26 faces generally downwards when the first sash 2 is in its vertical orientation in the main frame 1. The upper and lower walls 112,108 are arranged substantially parallel to one another, and are spaced apart by a distance that substantially matches the separation between the first and second sides 24,26. The upper wall 112 is longer than the lower wall 108. The lower wall 108 is relatively stubby. The lower wall 108 is arranged to extent across a small portion of the width of the lower side 26. This helps the connector 104 to engage and disengage the frame member 23. The connecting side wall 110 is arranged to engage a third (inner) side 28 of the first window frame. The side wall 110 is arranged to extend transversely across the full width of the inner side 28 of the frame member. The third side 28 is arranged substantially perpendicular to the first and second sides 24,26, and faces into a room in normal use.

The wall 106 is arranged to wrap around the frame member 23 and to engage a fourth (outer) side 29 of the frame member 23. The lower wall 106 is arranged to extend transversely across a portion of the width of the outer side 29, typically approximately 50% of the width. The fourth side 29 faces out of the room during normal use. The wall 110 includes a stepped portion 113 which curves 115 through approximately 90 degrees into the wall 106. The stepped portion and wall 106 presents a substantially L-shaped formation. The wall 106 includes a bulbous part 107. The bulbous part 107 bulges in a direction towards the side wall 110. The bulbous part 107 engages a groove formed in the outer side 29.

One of the actuators 16 can hold the connector 104 in engagement with the frame member 23. This prevents the connector 104 from disassociating from the frame member 23 in use, and prevents the connector 104 from sliding laterally with respect to the frame member 23 (except when the actuator is activated).

Two holes 180 are formed through the upper wall 112. The holes 180 are spaced apart. Each hole 180 is arranged to receive one of the threaded members 186. One of the actuators 16 can clamp the connector 104 to the frame member 23, for example by inserting the threaded member 186 into one of the holes 180 and then screwing the threaded member into the respective threaded hole 182 tightly. In this instance, the underside of the finger-grip part 184 firmly presses the upper wall 112 against the upper side 24 of the frame member. Typically, the underside of the finger-grip part 184 has a relatively large side area to spread the load across the upper wall 112. In use, only one actuator 16 is used to hold the connector 104 in engagement with the frame member 23. A user selects the appropriate hole 180 according to the position of the actuator 16.

Two holes 180 are provided to enable the connector 104 to be attached to either the right actuator 16 or the left actuator 16. This is necessary in this embodiment because of the positions of the actuators 16 with respect to the upper frame member 23. It will be appreciated by the skilled person that in some embodiments where the actuators have different positions with respect to the upper frame member 23, a single hole 180, for example centrally positioned in wall 112, may suffice to enable the connector 104 to be clamped be either the left actuator or the right actuator.

A support member 102 connector piece 116 is pivotally attached to the connector 104. The side wall 110 includes mounting portions 114 mounted on an outer side 125. The connector piece 116 includes a tubular main body and three mounting members 117, which protrude outwards from a closed end of the main body, in a forked arrangement. Gaps located between the mounting members 117 are arranged to receive the mounting portions 114. Thus the mounting portions 114 are interleaved with the mounting members 117. A pivot pin 118 passes through holes formed in the mounting members 117 and the mounting portions 114 to pivotally connect the connector piece 116 to the connector 104. The arrangement of the pivoting connection prevents the support member 102 from swinging laterally during use. That is, the support member 102 is restricted to pivoting movement in a plane.

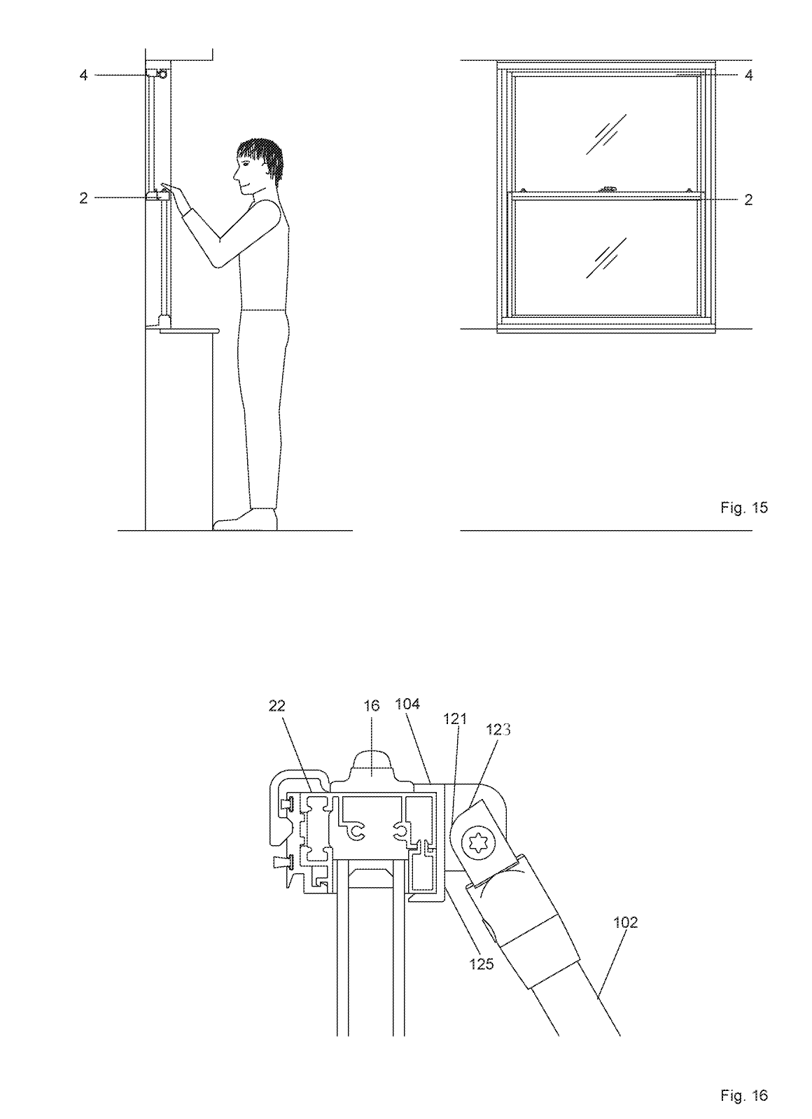

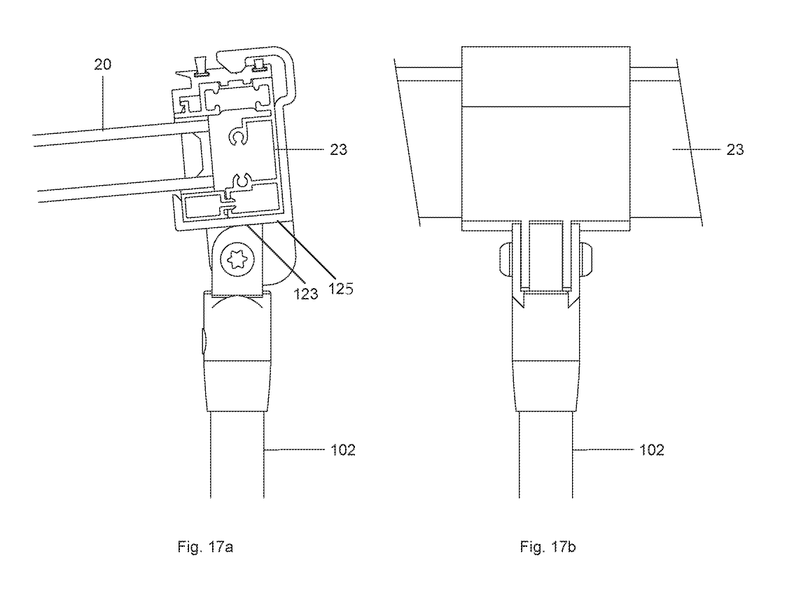

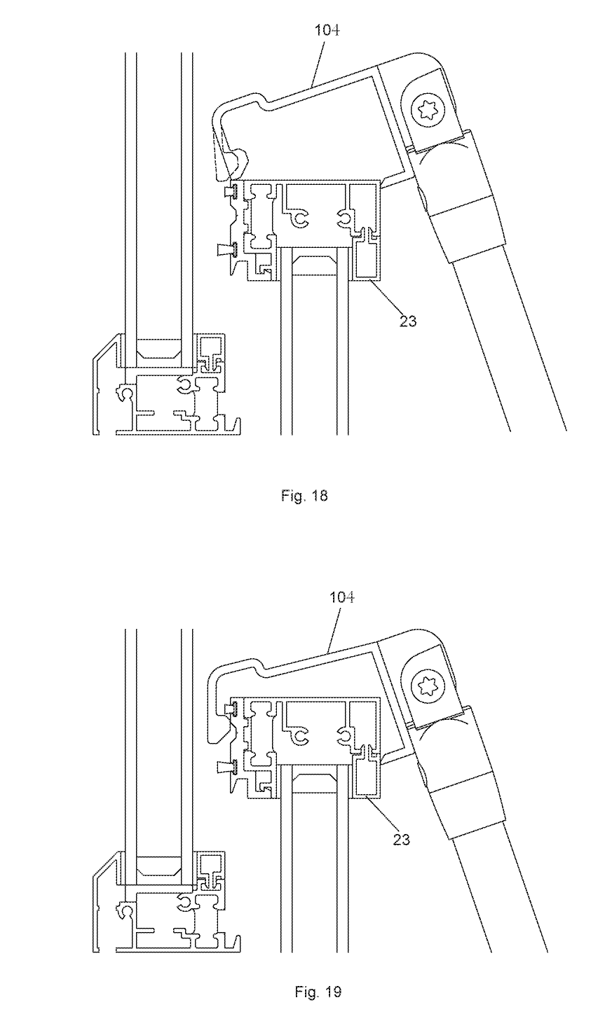

The mounting members 117 each have a profiled surface, which preferably includes an arcuate portion 121 and a planar portion 123, which is arranged to limit rotation of the support member 102 with respect to the connector 104. The profiled surface limits rotation of the support member with respect to the connector portion 104 in one rotational direction. The profiled surface interacts with a surface of the connector portion 104. Rotation of the support member 102 is blocked when the planar portion 121 engages the connector surface, which is preferably the outer surface 125 of side wall 110. FIG. 16 shows the support member 102 in a condition, where the planar portion 123 is not engaged with the connector portion 104 and therefore the support member 102 is able to pivot in both directions. FIGS. 17a and 17b show the support member 102 in a condition wherein the planar portion 123 has engaged surface 125, and wherein the support member 102 has reached its limit of rotation with respect to support member 102 in one direction. It will be appreciated that in FIGS. 17a and 17b the first sash 102 tends towards the horizontal in this condition, and the support member 102 is arranged substantially vertically.

The connector piece 116 is mounted on one end 120 of the support member 102. The connector piece includes a formation 119. A hole is drilled through the formation to accommodate a rivet (not shown), which attaches the connector piece 116 to the support member 102.

Preferably the connector 104 comprises a moulded plastics component. Preferably the member connector piece 116 comprises a moulded plastics component.

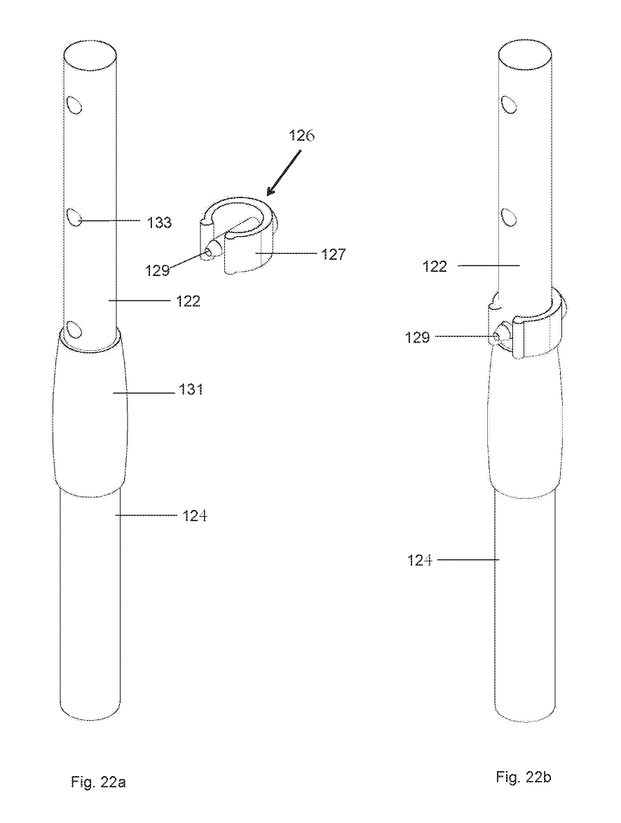

The purpose of the support member 102 is to support the first sash 2 in its tilted condition. The length of the support member 102 is sufficient to support first sash 102 from a surface, such as a floor 128. Preferably the length of the support member 102 is adjustable (see FIGS. 22a and 22b). The adjustable support post 102 includes first and second parts 122,124. The second part 124 is tubular. The first part 122 is mounted in the second part 124. The first part 122 is arranged to slide within the second part 124. Thus the first and second parts 122,124 are telescopically adjustable. The support member 102 includes a locking mechanism 126, which is arranged to fix the position of the first part 122 with respect to the second part 124. The locking mechanism 126 comprises a first collar 127 having a locking pin 129, a second collar 131 located towards an open end of the second part 124 and an arrangement of holes 133 formed in the first part 122. The user adjusts the length of the support member 102, by sliding the first part 122 with respect to the second part 124 and then locking the position of the first part 122 with respect to the second part by clipping the first collar 127 on to the first part 122, such that the locking pin 129 is inserted into one of the holes 133.

The support member 102 can include a foot 130, for example a rubber shoe to prevent the support member 102 from slipping on the surface 128.

A method of supporting the first and sashes 2,4 in tilted conditions, will now be described with reference to FIGS. 6 to 22b.

Starting from a closed window condition, wherein the first and second sashes 2,4 are in the vertical orientation, a user positions at least one, and typically first and second support members 102 adjacent the main frame 1 (see FIG. 6).

The user detaches the actuators 16 from latches 17. This is achieved by unscrewing the actuators 16.

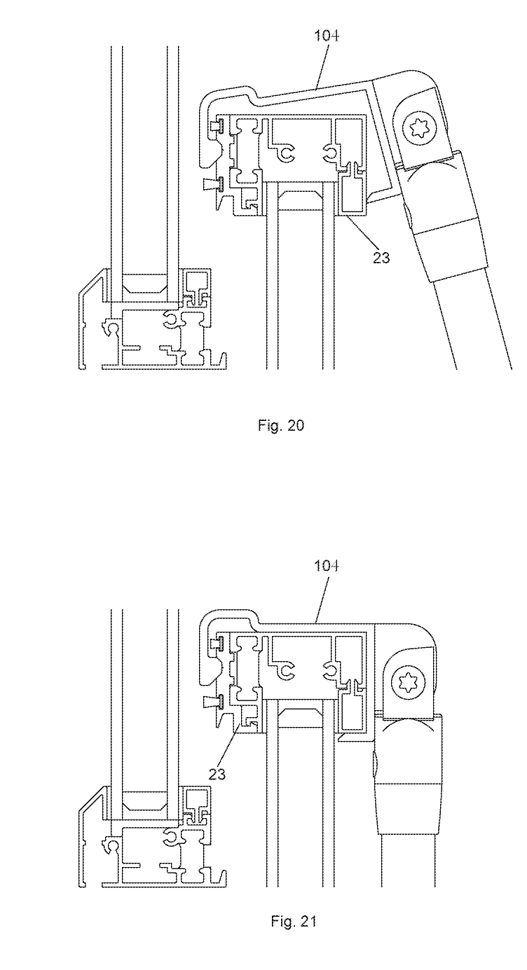

The user connects at least one support member 102, and typically a plurality of support members 102, to the first sash 2 (see FIG. 7). The support members 102 are typically spaced apart from one another along the frame member 23. The support members 102 are typically attached while the sash 2 is in the vertical orientation. The support members 102 are connected to the first window frame 22 via the connectors 104. In particular, each connector 104 is mounted onto first window frame 22, such that the hook formation latches on to the upper frame member 23. FIGS. 18 to 21 illustrate how the connector 104 flexes in a resilient manner as it is attached to the frame member 23. In particular, the wall 106 flexes sufficiently to enable the connector 104 to wrap around the frame member 23 (see FIGS. 18 and 19).

The user uses the actuators 16 to secure the connectors 104 to the window frame member 23. Thus the actuators 16 act as securing members. Each connector 104 is held in engagement with the frame member 23 by inserting one of the threaded members 186 into one of the holes 180 formed in the upper wall 112, and screwing the threaded member 186 into the respective threaded hole 182. When tightened sufficiently, each finger-grip part 184 clamps its respective connector 104 to the frame member 23.

At this stage, the support members 102 hang downwards from an upper part of the first sash 2.

The user then actuates latch actuators 16, which release latches 17, enabling the first sash 2 to pivot out of the plane of the main frame 1 about pivot bars 19 (see FIG. 8). If necessary, the clamping load applied to each connector 104 by its respective actuator 16 can be increased by tightening the actuators 16 further. At this stage, the user may adjust the lengths of the support members 102 by releasing the locking mechanism 126. It will be appreciated, that this step can take place prior to attaching the support members 102 to the window frame 22. As the first sash 2 pivots out of the frame, the connector pivot 120 ensures that the support member 102 hangs substantially vertically downwards. The first sash 2 pivots through an angle in the range 70 to 90 degrees, and typically through an angle around 80 to 85 degrees. Eventually the support members 102 engage the floor 128, via feet 130 (see FIG. 8). The first sash 2 is now supported by the support members 102 in the tilted condition.

FIG. 9 shows the user cleaning the first sash 2 with a cloth or sponge 140. It is apparent that the user can easily clean substantially the whole of the outer surface of the glazing unit 20.

The next step is for the user to actuate latch actuators 16 on the second sash 4. The user slides the second sash 4 downwards in the main frame 1, and tilts the second sash 4 out of the plane of the main frame 1 (see FIG. 10). The second sash 4 can be tilted to an extent that it engages and rests on the first sash 2. Optionally, the user can separate the first and second sashes 2,4 by a separating member 136, such as a block of foam.

The user is now able to clean substantially the whole of the outer side of the glazing unit in the second sash 4 with the cloth or sponge 140.

FIGS. 11 to 15 show how the window is closed. Firstly, the second sash 4 is rotated into the plane of the main frame 1, and latches 17 secure the second sash 4 in the vertical orientation in the main frame 1. The user then rotates the first sash 2 back into the plane of the main frame 1. The latches 17 secure the first sash 2 in the vertical orientation in the main frame 1. The user then unscrews the actuators 16 and unclips the connectors 104 from the first sash 2. The window assembly 10 is now returned to its original state.

The support assembly 100 can then be stored for future use, or can be moved to other window assemblies 10 in the building and the process can be repeated.

It will be appreciated that modifications can be made to the above embodiments that fall within the scope of the invention. For example, the support assembly can include only a single support member. Alternatively the support assembly can include at least one further support member, for example three, four or five support members.

Fixed length support members can be used in some applications.

An alternative support member locking mechanism can be used. For example, the locking mechanism can be of the type that includes first and second threaded elements. When the first and second threaded elements are screwed tightly together, at least one of the first and second threaded elements applies a compressive load to the first part 122, thereby fixing the position of the first part 122 with respect to the second part 124. That is, a twist-lock locking mechanism can be included. An alternative twist-lock locking mechanism can include an internal formation, such as a flange or cam, attached to the first part 122. The formation is shaped such that in a first rotational position of the first part 122 with respect to the second part 124, the internal formation engages an internal surface of the second part 124 thereby locking the longitudinal translational position of the first part 122 with respect to the second part 124. In a second rotational position of the first part 122 with respect to the second part 124, the formation disengages the internal surface of the second part 124 thereby unlocking the longitudinal translational position of the first part 122 with respect to the second part 124. In this condition the length of the support member 102 can be adjusted. The position can then be fixed by twisting the first part 122 with respect to the second part 124 to return to the first rotational position. Twisting the first part 122 with respect to the second part 124 in a first rotational direction locks the longitudinal translational positions. Twisting the first part 122 with respect to the second part 124 in a second rotational direction unlocks the longitudinal translational position of the first part 122 with respect to the second part 124. The formation can be arranged to change its shape and/or its radial position in response to relative rotational movement of the first part 122 with respect to the second part 124, thereby locking and/or unlocking the longitudinal translation position of the first part 122 with respect to the second part 124.

A brace can be used to fix the first and second support members together. The brace can extend transversely between the first and second posts. This is to help the support members to withstand accidental loading, for example a person bumping into the posts in use.

In the embodiments above, the connector is releasably attachable to the frame member by means of a hook formation. While this is the preferred means of attaching the support member to the window, other means can be used to releasably connect the support member to the window.

In some embodiments, the first and second connectors may include a single aperture 180. In these embodiments, the user can use the same aperture to selectively receive the first or second actuator.

In some embodiments the resiliency of each connector alone is sufficient to releasably secure the connector to the upper frame member. In these embodiments, it is not necessary to clamp the connectors to the upper frame member with the actuators. In these embodiments, the holes 180 can be omitted.

Optionally, a brace 200 (see FIG. 8) can be used to fix the first and second support members together. For example, the brace 200 can extend transversely between the first and second posts. This is to help the support members to withstand accidental loading, for example a person bumping into the posts in use. The brace 200 can comprise a fixed pole that can clip on to each of the first and second support posts. The brace 200 can a telescopic pole that can be attached to each of the first and second support posts. The brace 200 can comprise a sliding bar/bracket that can be attached to each of the first and second support posts. The brace 200 can be made from any suitable material. Preferably the brace 200 is made from plastic, for example can be a moulded or extruded component.

The latch 17 can include the threaded member 186 and finger-grip part 184 can include the threaded hole 182.

Instead of using the actuators 16 to secure the connectors 104 to the window frame, the securing members can comprise window frame screw elements to secure the connectors 104 to the window frame. For example, the window frame screw elements can be similar in construction to the actuators 16, so may be rotated by hand, however instead of screwing into latches 17, the screw elements are screwed directly into threaded holes formed in the window frame member 23.

What is claimed is:

1. A support assembly for supporting a tiltable window in a tilted condition, said tiltable window including a window frame, a latch for releasably securing the tiltable window in a vertical orientation in a main frame, the support assembly, including: a first support member arranged to be mounted on a surface, such as a floor, to support the tiltable window in the tilted condition; and a first connector attached to the first support member; wherein said first connector is arranged to be releasably attached to a window frame member prior to the tiltable window being tilted out of the plane of the main frame, and includes a frame that is arranged to at least partly envelope the window frame member.

2. A support assembly according to claim 1, wherein the first connector is arranged to be secured to the window frame by a securing member, such as an actuator arranged to actuate the latch in response to a user moving the actuator or a window frame screw element.

3. A support assembly according to claim 2, the first connector includes a formation, such as an aperture or recess, adapted to receive at least part of the securing member.

4. A support assembly according to claim 1, wherein the tiltable window includes a second latch, and the first connector includes a second formation, such as a second aperture or second recess, adapted to receive at least part of a second securing member, such as a second actuator arranged to actuate the second latch in response to a user moving the second actuator or a second window frame screw element.

5. A support assembly according to claim 1, wherein the window frame member is an upper frame member when the window is in its normal vertical orientation.

6. A support assembly according to claim 1, wherein at least part of the first connector is flexible and the first connector is adapted to clip on to the window frame member in a releasable manner.

7. A support assembly according to claim 1, wherein the window frame member has upper, lower, inner and outer sides when the window is in its normal vertical orientation within the main frame, wherein the first connector includes an upper wall arranged to engage the upper side of the window frame member.

8. A support assembly according to claim 7, wherein the first connector includes at least one of: an outer wall arranged to engage an outer side of the window frame member; an inner wall arranged to engage an inner side of the window frame member; and a lower wall arranged to engage a lower side of the window frame member.

9. A support assembly according to claim 7, wherein first connector includes the upper, lower, inner and outer walls, said walls defining the frame arranged to partly envelope the window frame member.

10. A support assembly according to claim 9, wherein the first connector includes an opening located between the outer wall and the lower wall to receive part of the window frame member.

11. A support assembly according to claim 9, wherein the upper and lower walls protrude perpendicularly from an inner side of the inner wall and the outer wall protrudes perpendicularly from an inner side of the upper wall.

12. A support assembly according to claim 1, wherein the first connector comprises a moulded plastics component.

13. A support assembly according to claim 1, wherein the first connector is pivotally attached at one end of the first support member.

14. A support assembly according to claim 13, wherein each of the first connector and the first support member includes a plurality of mounting members, the mounting members of the first connector are interleaved with the mounting members of the first support member, and a pivot pin pivotally connects the first connector mounting members to the support member mounting members, wherein at least one of the mounting members includes a profiled side that is arranged to engage with one of the first connector and the first support member in order to limit relative pivoting movement of first connector with respect to the first support member.

15. A support assembly according to claim 1, wherein the length of the first support member is adjustable,

16. A support assembly according to claim 15, wherein the first support member includes first and second parts that are moveable with respect to one another, and a locking mechanism for fixing the position of the first part with respect to the second part.

17. A support assembly according to claim 1, including a second support member.

18. A support assembly according to claim 17, including a brace for connecting the first and second supports together.

19. A support assembly according to claim 1, wherein at least one of the first and second support members comprises a support post.

20. A window system, comprising: a support assembly including a first support member arranged to engage a surface, such as a floor, to support the first window in the tilted condition, and a first connector attached to the first support member; and a window assembly having a main frame, a first window having a first window frame, and a latch arranged to releasably secure the first window in a vertical orientation in the main frame; wherein the first window is pivotally mounted in the main frame such that the first window is tiltable out of the plane of the main frame by pivoting the first window about a first pivot axis; the first connector is arranged to be releasably attached to a window frame member while the first window is in a substantially vertical orientation within the main frame, the first connector including a frame that is arranged to at least partly envelope the window frame member.

21. A window system according to claim 20, wherein a securing member, such as and an actuator arranged to actuate the latch in response to a user moving the actuator or a window frame screw element, is arranged to releasably secure the first connector to the first window frame.

22. A window system according to claim 20, wherein the position of the securing member is adjustable with respect to at least one of the latch and window frame.

23. A window system according to claim 20, the securing member is releasably attachable to one of the latch and window frame.

24. A window system according to claim 20, wherein the first connector includes a formation, such as a hole or recess, and at least part of the securing member is arranged to engage the formation to secure the first connector to the window frame member.

25. A window system according to claim 21, wherein at least one of the actuator and the latch includes a threaded member and the other of the actuator and the latch includes a threaded hole, wherein the position of the actuator with respect to the latch is adjustable by rotating the threaded member within the threaded hole.

26. A window system according to claim 20, wherein the first window includes a second latch arranged to releasably secure the first window in the vertical orientation in the main frame; the support assembly includes a second support member and a second connector attached to the second support member, the second connector is arranged to releasably attach the second support member to the first window frame; and the window includes a second securing member, such as a second actuator arranged to actuate the second latch in response to a user moving the second actuator or a second window frame screw element, arranged to releasably secure the second connector to the first window frame.

27. A window system according to claim 26, wherein the position of the second securing member is adjustable with respect to at least one of the second latch and the first window frame, and the second securing member is arranged to clamp the second connector member to the first frame member.

28. A window system according to claim 27, wherein at least one of the second actuator and the second latch includes a second threaded member and the other of the second actuator and the second latch includes a second threaded hole, wherein the position of the second actuator with respect to the second latch is adjustable by rotating the second threaded member within the second threaded hole.

29. A window system according to claim 20, wherein the window assembly comprises a sash window assembly, at least one of the first and second windows is arranged to slide vertically within the main frame and at least one of the first and second pivot axes is arranged horizontally.

30. A method for supporting a tiltable window, including providing a window assembly including a main frame and a first window, the first window having a first window frame, and a latch for releasably securing the first window in a vertical orientation in the main frame, wherein the first window is pivotally mounted in the main frame; providing a support assembly including a first support member and a first connector attached to the first support member, said first connector including a frame that is arranged to at least partly envelope a window frame member; releasably attaching the first connector to a window frame member of the first window frame while the first window is in a substantially vertical orientation within the main frame; tilting the first window out of the plane of the main frame by pivoting the first window about a first pivot axis; and mounting the first support member on a surface, such as a floor, such that the first support member supports the first window in the tilted condition.

31. A method according to claim 30, including adjusting the position of a securing member, such as an actuator arranged to actuate the latch in response to a user moving the actuator or a window frame screw element, with respect to at least one of the latch and window frame, and releasably securing the first connector to the first window frame with the securing member.

32. A method according to claim 30, wherein the first window includes a second latch arranged to releasably secure the first window in the vertical orientation in the main frame; the support assembly includes a second support member and a second connector attached to the second support member; and including releasably attaching the second connector to the first window frame; releasably securing the second connector to the first window frame with a second securing member, such as a second actuator arranged to actuate the second latch in response to a user moving the second actuator or a second window frame screw element; mounting the second support member on a surface, such as the floor, such that the second support member supports the first window in the tilted condition.

33. A method according to claim 32, including adjusting the position of the second securing member with respect to at least one of the second latch and the first window frame, and clamping the second connector to the first window frame with the securing member.

34. A support assembly for supporting a tiltable window in a tilted condition, the support assembly, including: a first support member mountable on a surface, such as a floor, to support the window in the tilted condition; and a first connector attached to the first support member; wherein at least part of the first connector is arranged to flex resiliently and said first connector is adapted to clip on to a window frame member in a releasable manner thereby releasably attaching the first support member to the window, the first connector is pivotally attached to the first support member thereby enabling the first support member to change its orientation with respect to the window as the window is moved to the tilted condition.
